(19) United States
(12) Patent Application Publication
(10) Pub. No.: US 2012/0062554 A1
(43) Pub. Date: Mar. 15, 2012

(54) REPRODUCING APPARATUS

(76) Inventors: Takamasa Ueno, Hyogo (JP); Kentaro Tanikawa, Osaka (JP)

(21) Appl. No.: 13/204,006

(22) Filed: Aug. 5, 2011

(30) Foreign Application Priority Data
Aug. 6, 2010 (JP) 2010-177222

(51) Int. Cl. G06T 15/00

(52) U.S. Cl. 345/419

(57) ABSTRACT

The still image data includes still image data with a first format capable of being two-dimensionally displayed and still image data with a second format capable of being three-dimensionally displayed. The display controller has a two-dimensional mode and a three dimensional mode for respectively outputting the still image data in a format for two-dimensional display and a format for three-dimensional display as an operating mode. The display controller outputs image information for selectively displaying a first list including the still image data with the first format and the second format, and a second list including only the still image data with the second format on the display apparatus. When receiving an instruction for reproducing the still image data in a state that the first list is displayed, the display controller outputs the still image data included in the first list to the display apparatus in the two-dimensional mode.

### BACKGROUND

1. Technical Field

The present invention relates to a reproducing apparatus that can read information from a recording medium which stores a plurality of still image data and display the information on a display apparatus.

2. Related Art

Digital still cameras of recent years can capture not only two-dimensional photos but also three-dimensional photos. With such digital still cameras, two-dimensional image data and three-dimensional image data are recorded as image data in the same recording medium.

JP-2008-108362A discloses a reproducing apparatus. When reproducing files of various formats, such as a moving image file, a music file and a still image file, recorded in a recording medium, the reproducing apparatus can continuously reproduce only the moving image file, only the music file or only the still image file for each of file groups.

Two-dimensional image data and three-dimensional image data are still image data, namely, the same type of data.

Therefore, when only a still image file is reproduced by the method disclosed in JP-2008-108362A, two-dimensional image data and three-dimensional image data are continuously reproduced.

When a three-dimensional photo is captured, both two-dimensional image data and three-dimensional image data are occasionally recorded. In such a case, when still image data are continuously displayed by using the method described in JP-2008-108362A, two-dimensional photos and three-dimensional photos are alternatively displayed.

In a display apparatus connected to a reproducing apparatus via an interface such as HDMI, when two-dimensional image data and three-dimensional image data are continuously received from the reproducing apparatus and are displayed, switching of display control between control for 2D display and control for 3D display is necessary. At the time of the switching of the display control, in the reproducing apparatus and the display apparatus, settings are changed between a reproducing process of a two-dimensional photo and a reproducing process of a three-dimensional photo, so that a defect of a display screen may occur.

### SUMMARY

The present invention is devised in order to solve the above problem, and its object is to provide a reproducing apparatus that can read information from a recording medium storing two-dimensional image data and three-dimensional image data as the still image data in a mixed manner and reproduce the information, being capable of preventing a display defect on a display apparatus due to change between two-dimensional display and three-dimensional display.

A reproducing apparatus for reading still image data from a recording medium which stores a plurality of still image data and outputting information about the read still image data to a display apparatus. The reproducing apparatus includes an operation receiving unit operable to receive an instruction by operation, and a display controller operable to control image information for controlling an image to be displayed on the display apparatus. The plurality of the still image data includes still image data with a first format capable of being two-dimensionally displayed and still image data with a second format capable of being three-dimensionally displayed. The display controller has a two-dimensional mode for outputting the still image data in a format for two-dimensional display and a three-dimensional mode for outputting the still image data in a format for three-dimensional display as an operating mode. The display controller outputs image information for selectively displaying a first list including the still image data with the first format and the still image data with the second format, and a second list including only the still image data with the second format on the display apparatus. When receiving an instruction for reproducing the still image data in a state that the first list is displayed, the display controller outputs the still image data included in the first list to the display apparatus in the two-dimensional mode.

According to the present invention, when instruction of reproduction is made in a state that a first list is displayed, all still image data included in the first list are output to the display apparatus in the two-dimensional mode. For this reason, even when the first list includes still image data (two-dimensional image data) with the first format and still image data (three-dimensional image data) with the second format in a mixed manner, an authentication process and the like that is performed at the time of switching between two-dimensional display and three-dimensional display is not performed in the display apparatus, and thus a defect of display due to the authentication process and the like does not occur accordingly.

### BRIEF DESCRIPTION OF DRAWINGS

FIG. 1 is a diagram illustrating a relationship between a reproducing apparatus and an external device according to a first embodiment.

FIG. 2 is a diagram illustrating a file structure of data in a recording medium according to the first embodiment.

FIG. 3A is a diagram illustrating a configuration of a JPEG file format.

FIG. 3B is a diagram illustrating a configuration of an MPO file format.

FIG. 4 is a diagram illustrating configurations of the reproducing apparatus and a display apparatus according to the first embodiment.

FIG. 5 is a diagram illustrating a screen example of a photo list.

FIG. 6 is a diagram illustrating an example of a message screen to be displayed at the time when the display apparatus is switched into a 3D reproducing mode.

FIG. 7 is a diagram for describing setting of a display mode according to the first embodiment.

FIGS. 8A to 8E are diagrams for describing examples of three-dimensional image transmission (display) systems.

FIG. 9 is a diagram illustrating an example of a message screen for notifying of the switching into the 3D reproducing mode in the display apparatus.

FIG. 10 is a diagram illustrating an example of a screen to be displayed during an operation for switching from a 2D reproducing mode into the 3D reproducing mode in the display apparatus.

FIG. 11 is a diagram illustrating an example of a screen of a photo list.

FIG. 12 is a diagram illustrating an example of a message screen to be displayed at the time of switching into the 2D reproducing mode in the display apparatus.

FIG. 13 is a diagram illustrating a display example of a photo list when a folder is selected.

FIG. 14 is a diagram illustrating a display example of a photo list when a folder is selected.

FIG. 15 is a flowchart for describing a reproducing process in a two-dimensional mode according to the first embodiment.

FIG. 16 is a flowchart for describing a reproducing process in a three-dimensional mode according to the first embodiment.

FIG. 17 is a flowchart for describing an operation for setting the display node according to a second embodiment.

### DETAILED DESCRIPTION OF PREFERRED EMBODIMENT

### First Embodiment

An embodiment will be described below with reference to the attached drawings.

### 1. System Configuration

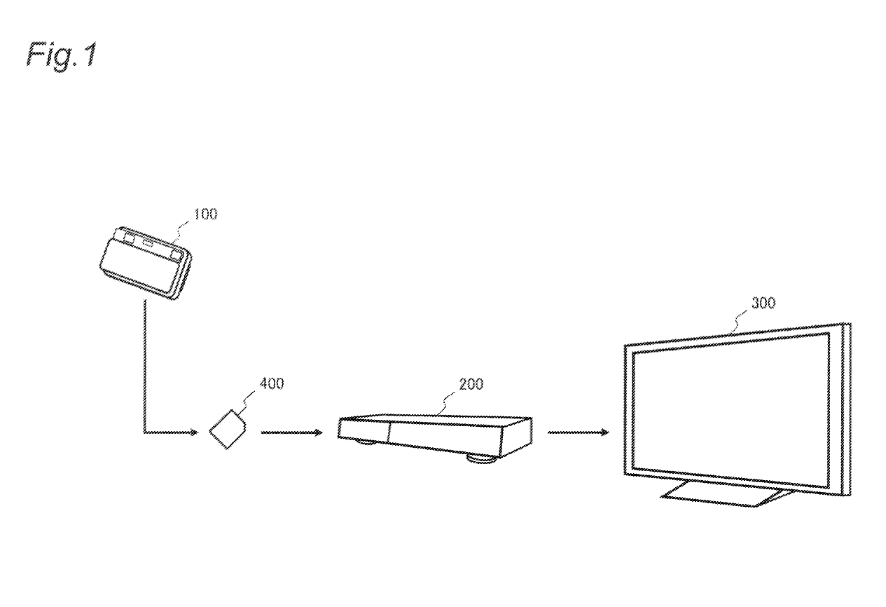

FIG. 1 illustrates an example of a reproducing system according to a first embodiment.

The reproducing system according to the first embodiment includes a camera 100, a reproducing apparatus 200, a display apparatus 300 and a recording medium 400.

The camera 100 can capture a subject image formed on an imaging device via a lens and can record still image data in the recording medium 400. Concretely, the camera 100 captures a subject image formed on the imaging device via the lens as a two-dimensional photo that can be displayed two-dimensionally and a three-dimensional photo that can be displayed three-dimensionally. The camera 100 can record still image data about the captured two-dimensional photo and three-dimensional photo in the recording medium 400.

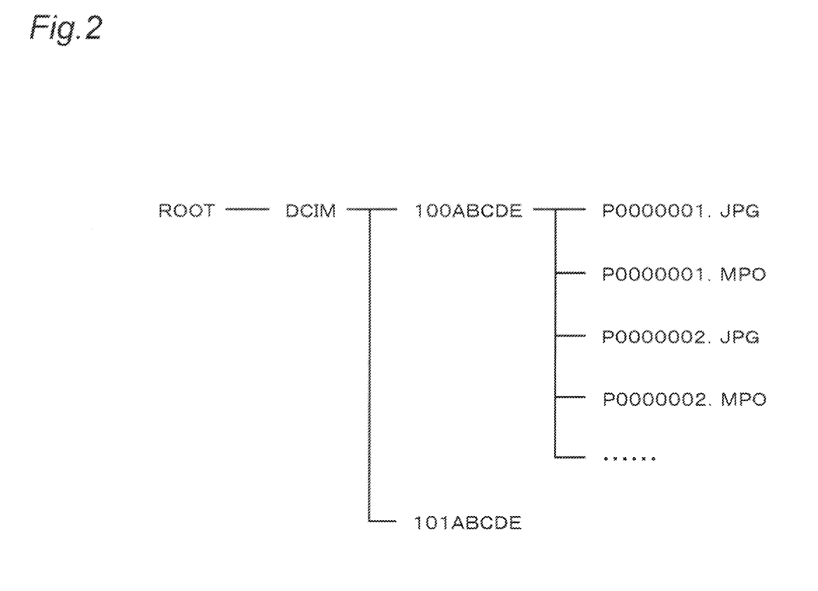

The recording medium 400 is a medium such as an SD card or a USB memory card. The first embodiment will be described in a state that information shown in FIG. 2 is recorded in the recording medium 400. FIG. 2 will be described later.

The reproducing apparatus 200 can read and reproduce various files recorded in the recording medium 400. The reproducing apparatus 200 can output the information read from the recording medium 400 as an image signal to the display apparatus 300. A configuration and an operation of the reproducing apparatus 200 will be described later.

The display apparatus 300 receives a video signal transmitted from the reproducing apparatus 200, and can display a video represented by the received video signal. The display apparatus 300 can display a three-dimensional video. The display apparatus 300 has a 2D reproducing mode and a 3D reproducing mode. The 2D reproducing mode is for displaying the video signal received from the reproducing apparatus 200, as a two-dimensional video. The 3D reproducing mode is for displaying the video signal received from the reproducing apparatus 200, as a three-dimensional video. The display apparatus 300 can be realized by a liquid crystal display, an organic EL display, or the like. The display apparatus 300 provides a three-dimensional video using active shutter eyeglasses to a user. The display apparatus 300 is compatible with various 3D video signals, and can display a video signal transmitted from the reproducing apparatus 200 three-dimensionally according to a frame sequential system.

When still image data is displayed with the frame sequential system, image data for left eye and image data for right eye of three-dimensional image data are alternatively transmitted by each frame. That is to say, after the reproducing apparatus 200 transmits image data for left eye as data of one frame, for example, the reproducing apparatus 200 transmits image data for right eye as data of one frame.

### <2. One Example of Image Data>

FIG. 2 is a diagram illustrating structures of a directory, folders and files generated in the recording medium 400. A ROOT directory is provided with a folder DCIM which stores the captured data. The folder DCIM is provided with folders such as 100ABCDE and 101ABCEE (hereinafter, “photo-folders”). Captured data (files) such as “P0000001.JPG”, “P0000001.MPO”, “P0000002.JPG” and “P0000002.MPO” are stored as still image data in the photo-folder. A file of which extension is “JPG” is recorded in a file format of JPEG (Joint Photographic Experts Group). Hereinafter, the file is suitably described as “JPEG file”. Further, a file of which extension is “MPO” is recorded in a format of MPO (Multi-Picture Format). Hereinafter, the file is suitably described as “MPO file”.

The MPO file includes a plurality of images (hereinafter, the respective images are “individual images”). The individual images are provided with classification codes. Examples of the classification codes are described below.

Classification Information Classification code

Baseline MP Main Image: 0301

Monitor Display Image Class 1 VGA correspondence: 0101

Monitor Display Image Class 2 Full HD correspondence:

Multi-View individual Image Panorama: 0201

Multi-View Individual Image Stereoscopic View: 0202

Multi-View Individual image Multi-Angle: 0203

The MPO file format enables a plurality of still image data (image data) to be packed into one file (see “CIPA DC-007-2009 issued by Camera & Imaging Products Association in February, 2009”).

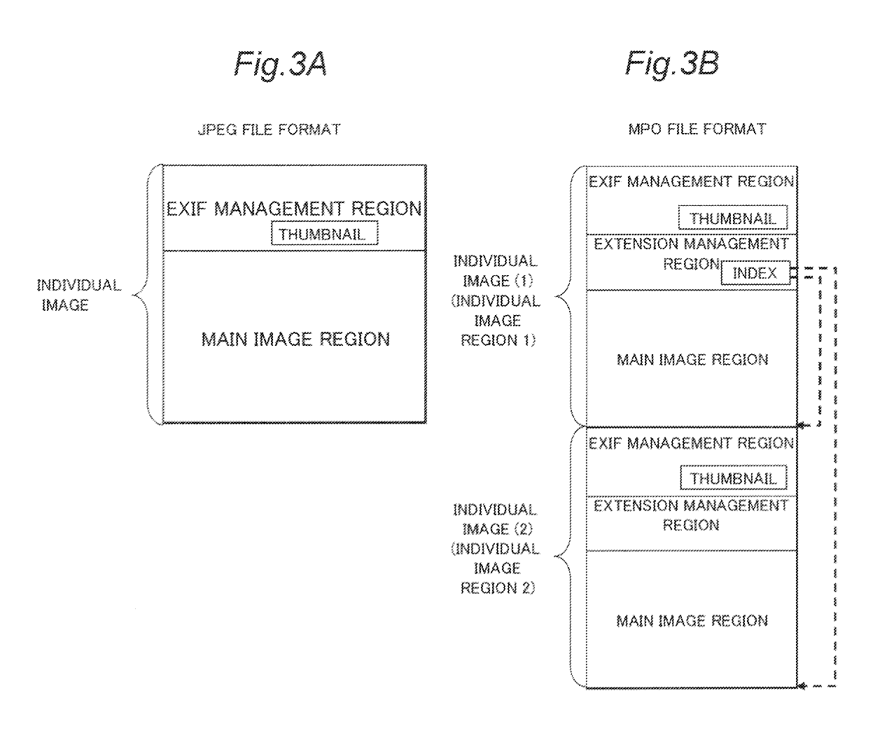

JPEG file format enables one individual image (still image) to be recorded in one file. FIG. 3A is a diagram describing the JPEG file format. A JPEG file is provided with an Exif management region and a main image region as data storage regions as shown in FIG. 3A. A thumbnail image can be stored in the Exif management region. Image data is stored in the main image region. As a result, two-dimensional image data is recorded in the JPEG file format.

FIG. 3B is a diagram describing the MPO file format. In the MPO file format, a plurality of individual images (still images) can be recorded in one file. The individual images are managed in individual image regions. For this reason, a plurality of individual image regions are present in one file as shown in FIG. 3B. FIG. 3B illustrates a case where two individual image regions are present. The individual image regions are provided with an Exif management region, an extension management region and a main image region as data storage regions. A thumbnail image can be stored in the Exif management region. The above-described classification codes are stored in the extension management region. Further, individual image numbers are stored in the extension management region. The individual image numbers are given in ascending sequence starting from 1. Index information is stored in the extension management region of the individual image 1 as a head image. Image data is stored in the main image region. Three-dimensional image data is recorded in the MPO file format with a classification code: 0202 and classification information: “multi-view individual stereoscopic view”. Even in the case of two-dimensional image data, some data having a large thumbnail are recorded in the MPO format.

The reproducing apparatus 200 can determine a type of photo image recorded in the MPO file by checking the classification codes stored in the extension management region.

### 2. Configurations of the Reproducing Apparatus and the Display Apparatus

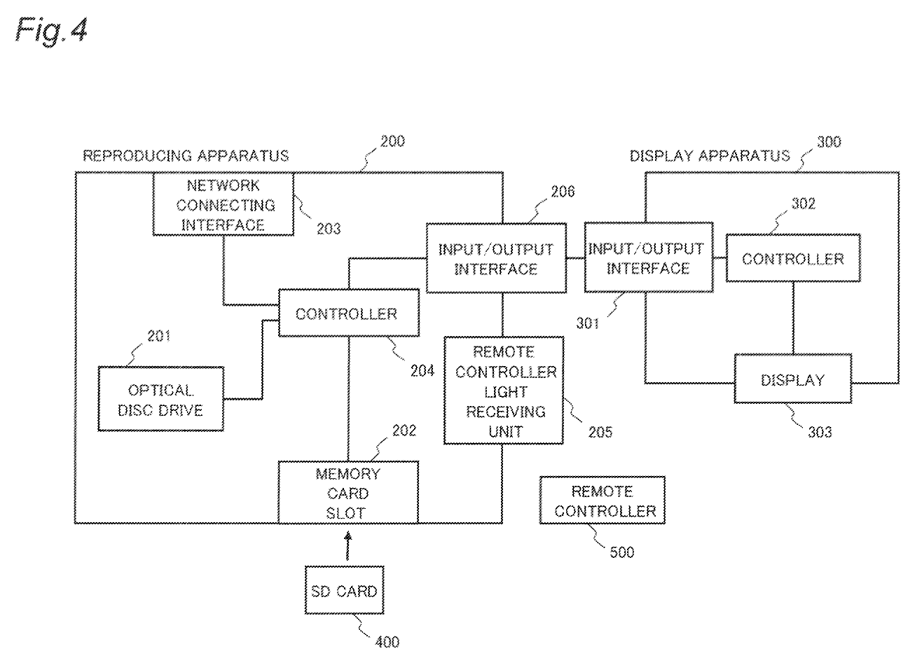

The configurations of the reproducing apparatus and the display apparatus will be described below with reference to FIG. 4.

### 2-1. Configuration of the Reproducing Apparatus

The reproducing apparatus 200 has an optical disc drive 201, a memory card slot 202, a network connecting interface 203, a remote controller light receiving unit 205, an input/output interface 206 and a controller 204.

The optical disc drive 201 can read information from an optical disc.

The recording medium 400 can be attached and detached into and from the memory card slot 202, and information can be read from the recording medium 400.

The network connecting interface 203 is an interface for connecting to an external apparatus via a network.

The remote controller light receiving unit 205 can receive an operation signal from a remote controller 500.

The input/output interface 206 can transmit and receive a video signal, a sound signal and a data signal to and from the display apparatus 300. The input/output interface 206 can be realized by an HDMI interface. In the first embodiment, the reproducing apparatus 200 and the display apparatus 300 are connected by an HDMI cable.

The controller 204 can control respective units of the reproducing apparatus 200. The controller 204 can be realized by LSI. Detailed operations of the controller 204 will be described later.

The reproducing apparatus 200 has a two-dimensional mode and a three-dimensional mode as display modes (operation modes). The two-dimensional mode is for outputting data that can be displayed two-dimensionally to the display apparatus 300. The three-dimensional mode is for outputting data that can be displayed three-dimensionally to the display apparatus 300. The reproducing apparatus 200 can switch the display mode between the two-dimensional mode and the three-dimensional mode, and performs different operations according to the set display mode.

The remote controller 500 has various operation buttons such as a cross key and the like. The remote controller 500 receives an operation instruction from a user via the operation button, and transmits a control signal according to that instruction to the reproducing apparatus 200. The reproducing apparatus 200 receives the signal transmitted from the remote controller light receiving unit 205, and transmits it to the controller 204.

### 2-2. Configuration of the Display Apparatus

The display apparatus 300 has an input/output interface 301, a display 303 and a controller 302.

The input/output interface 301 can transmit and receive a video signal, a sound signal and a data signal to and from the reproducing apparatus 200. The input/output interface 301 can be realized by an HDMI interface.

The display 303 can be realized by a liquid crystal display or an organic EL display or the like.

The controller 302 controls the respective units of the display apparatus 300. The controller 302 can be realized by LSI.

### 3. Operation of the Reproducing Apparatus

An operation of the reproducing apparatus 200 according to the first embodiment will be described.

First, display screen transition of a photo list (picture list) and the operation of the reproducing apparatus will be described, and then the reproducing operation of the reproducing apparatus will be described. Hereinafter, the operation of the reproducing apparatus 200 will be mainly described, but the operation of the reproducing apparatus 200 is performed with the respective units operating based on the control of the controller 204.

### 3-1. Outline

A case that, when the recording medium 400 is attached to the reproducing apparatus 200 and the display apparatus 300 is connected to the reproducing apparatus 200, the user reproduces image data (photos) recorded in the recording medium 400, will be described. In the reproducing apparatus 200, the display mode is set to the two-dimensional mode.

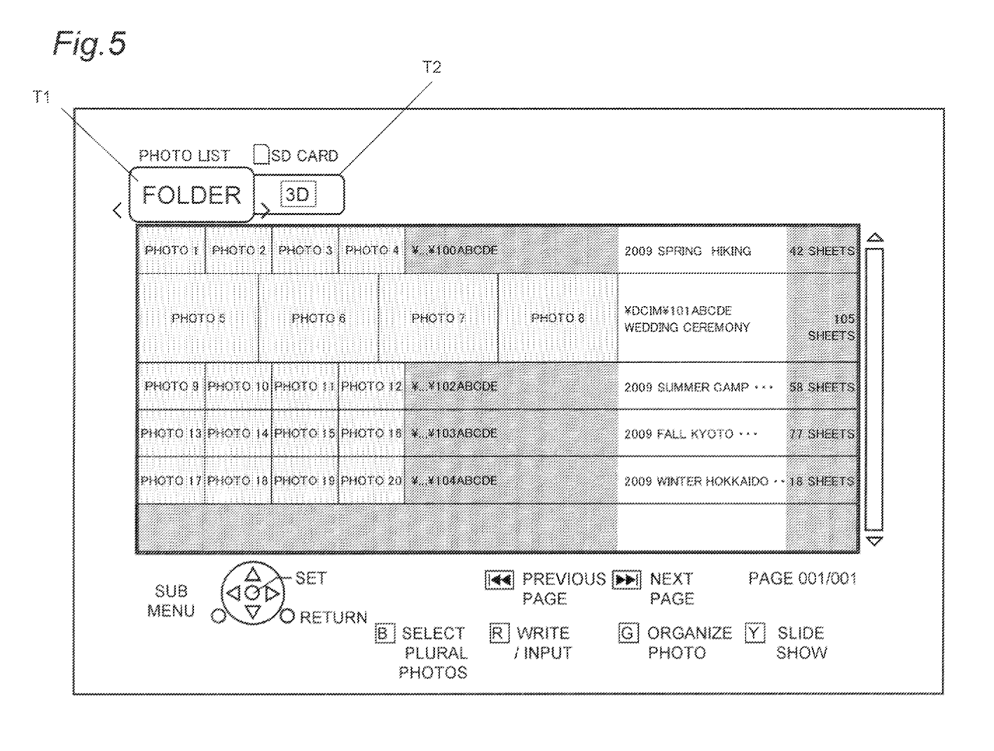

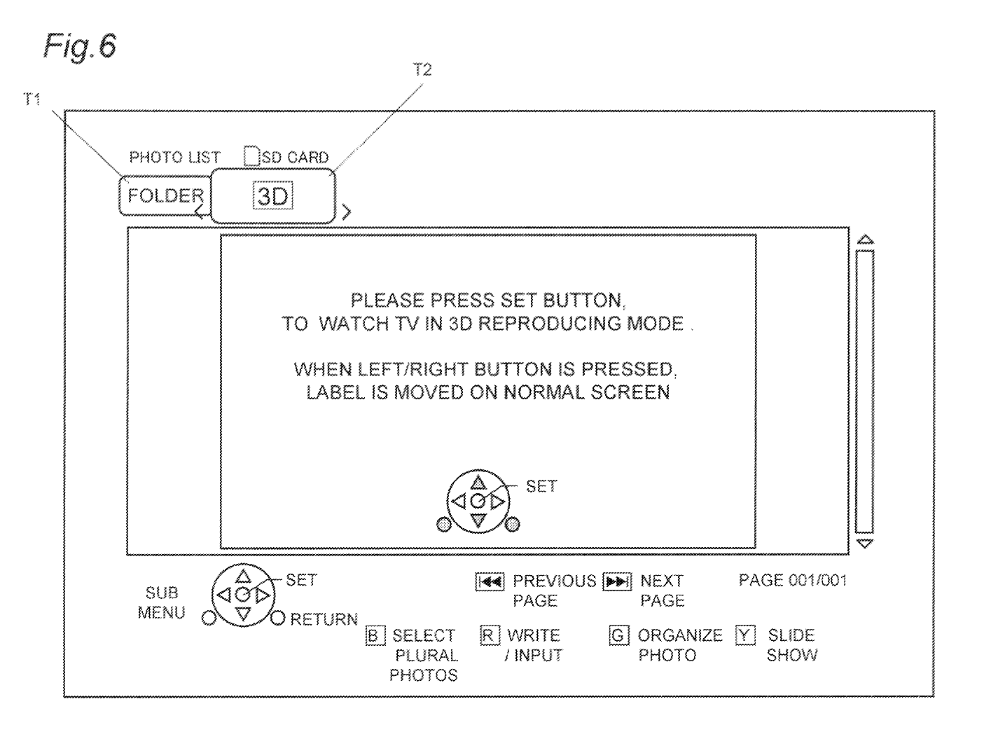

The reproducing apparatus 200 displays a photo list as shown in FIG. 5 on the display apparatus 300 according to a user's operation for instructing display of a photo list. The photo list is switched by two tabs including a “folder” tab T1 and a “3D” tab T2. The “folder” tab T1 is selected when a list of image data including image data with a two-dimensional format and image data with a three-dimensional format is displayed. The “3D” tab T2 is selected when a list of image data that does not include image data with a two-dimensional format but includes image data with a three-dimensional format is displayed. FIG. 5 illustrate an example of the photo list (a first list) displayed when the “folder” tab T1 is selected. FIG. 6 illustrates an example of the photo list (a second list) that is displayed when the “3D” tab T2 is selected. In the first embodiment, when the “folder” tab T1 is selected, a file with the JPEG file format (a JPEG file) and a file with the MPO file format (an MPO file) are read and are displayed as a list. When the “3D” tab T2 is selected, a file with the MPO format is read and the list is displayed.

The two tabs T1 and T2 can be selected by a user's operation of the remote controller (operation of right and left keys). In the first embodiment, the photo list which is to be displayed when the “folder” tab T1 is selected is displayed as an initial screen.

When the “folder” tab T1 is selected, the reproducing apparatus 200 reads a JPEG file and an MPO file from captured data recorded in each photo-folder of the recording medium 400 in order to display the corresponding photo list. Concretely, the reproducing apparatus 200 reads the files of which extensions are “JPG” or “MPO”. That is to say, the reproducing apparatus 200 reads all still image data in each photo-folder. The reproducing apparatus 200 displays some thumbnail images included in the read files on a photo list. In the example shown in FIG. 5, four thumbnail images (in FIG. 5, portions shown as photos 1 to 20) are displayed in each photo-folder.

When the “3D” tab T2 is selected by a user's operation of the right and left keys, the reproducing apparatus 200 operates as follows. In the middle of the user's operation, the reproducing apparatus 200 does not perform the following operation. The middle of the operation means a state that a pressing-down state of the left key or right key is being maintained. If the process is performed in the middle of the user's operation and the content of operation is changed, the performed process is to be wasted, but such a waste can be avoided according to in the first embodiment. Further, the wasted process is not performed, the speed of a display process can be further heightened.

After the user's operation is completed, when the “3D” tab T2 is selected, the reproducing apparatus 200 displays a screen that notifies of that the display format is switched from the two-dimensional display into three-dimensional display on the display apparatus 300 as shown in FIG. 6. The reproducing apparatus 200 provides this screen for notification to the user to allow the user to know that photos are stereoscopically displayed (three-dimensionally display). As a result, the user is not amazed at sudden display of the stereoscopic photos (the three-dimensional photos). Further, user's willingness (willingness to change from two-dimensional display into three-dimensional display) can be confirmed.

Thereafter, when the user presses down the set button, the reproducing apparatus 200 performs an authentication operation with respect to the display apparatus 300. Concretely, the reproducing apparatus 200 checks whether the display apparatus 300 can perform three-dimensional display using a predetermined three-dimensional display system. When the three-dimensional display can be performed by using the predetermined three-dimensional display system, the display mode is set to the three-dimensional mode. On the other hand, when the display apparatus 300 cannot display using the predetermined three-dimensional display, the reproducing apparatus 200 sets the display mode to the two-dimensional mode.

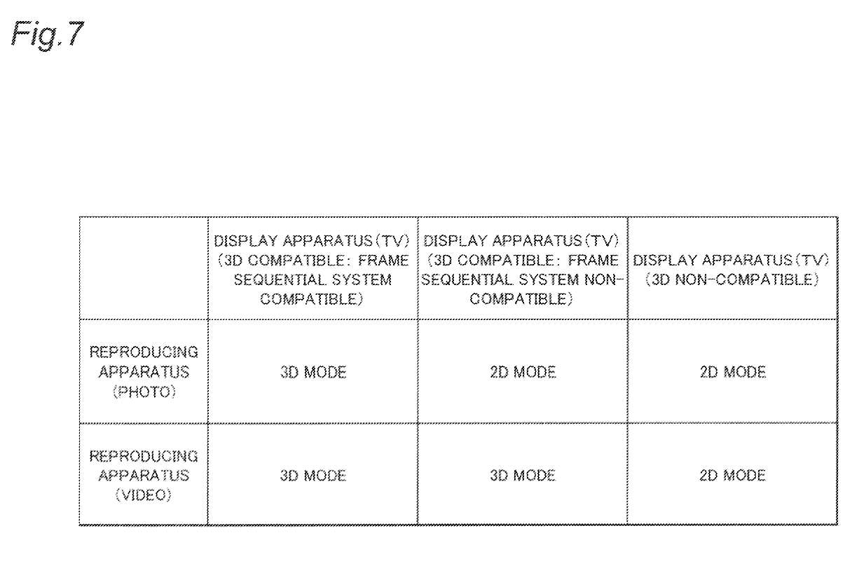

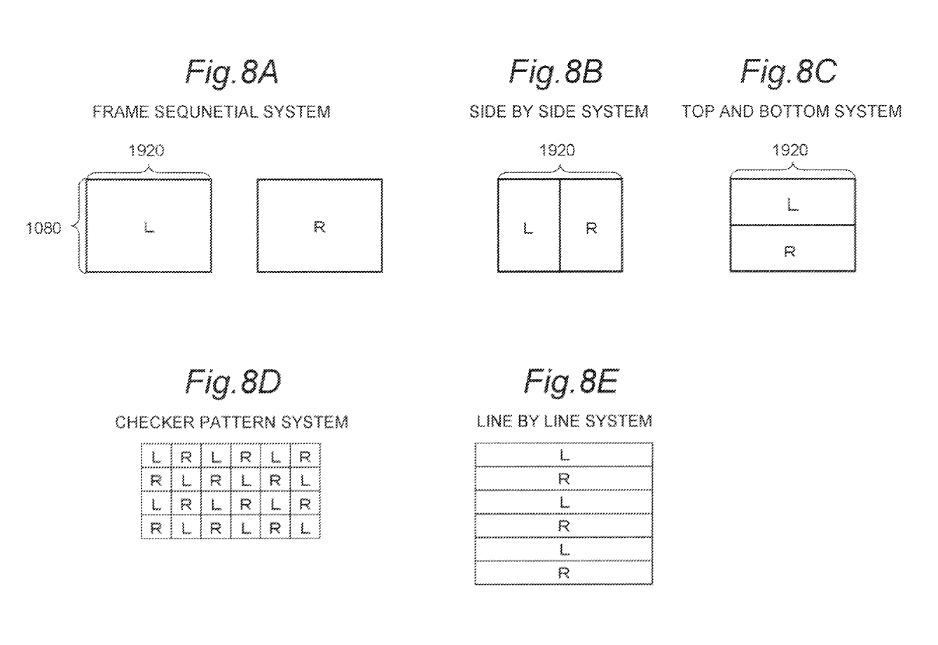

Concretely, the reproducing apparatus 200 refers to table information in FIG. 7 to perform the authentication operation. FIG. 7 is table information illustrating a relationship between 3D display compatibility of the display apparatus 300 and the display mode of the reproducing apparatus 200. According to the table information in FIG. 7, when an image to be reproduced is a still image (photo), the reproducing apparatus 200 determines whether the display apparatus 300 is compatible with the frame sequential system. The frame sequential system is one of three-dimensional data transmitting systems that transmits alternately in terms of time an image for left eye (L) and an image for right eye (R) shown in FIG. 8A. A determination whether the display apparatus 300 is compatible with the frame sequential system can be made based on information obtained by communication with the display apparatus 300. When the interface of the reproducing apparatus 200 and the display apparatus 300 is HDMI, the compatibility with the frame sequential system can be determined whether the HDMI is HDMI ver 1.4a.

When the display apparatus 300 is compatible with the frame sequential system, the reproducing apparatus 200 sets the display mode of the self apparatus to the three-dimensional mode. On the other hand, when the display apparatus 300 is not compatible with the frame sequential system, the reproducing apparatus 200 sets the display mode of the self apparatus to the two-dimensional mode.

On the other hand, when an image to be reproduced is a moving image (video), the reproducing apparatus 200 determines whether the display apparatus 300 is compatible with the 3D display. That is to say, the determination is made whether the display apparatus 300 is compatible with any of the three-dimensional data transmitting systems other than the frame sequential system. The three-dimensional data transmitting systems other than the frame sequential system includes, for example, a side-by-side system, a top-and-bottom system, a checker system and a line-by-line system shown in FIGS. 8B to 8E.

In the first embodiment, the method for setting the display mode is made different between a case where a moving image (video) is reproduced and a case where a still image (photo) is reproduced. That is to say, in reproducing a still image, if the display apparatus 300 is compatible with the frame sequential system, the reproducing apparatus 200 operates in the three-dimensional mode. On the other hand, in reproducing a moving image, even if the display apparatus 300 is not compatible with the frame sequential system but is compatible with another three-dimensional data transmitting system and can perform the three-dimensional display, the reproducing apparatus 200 operates in the three-dimensional mode.

According to such a control, a still image of a 3D system is allowed only to be transmitted by the frame sequential system. That is to say, even when an original still image is an image of a 3D system, if the display apparatus 300 is not compatible with the frame sequential system, the still image of the 3D system is transmitted by the 2D system. In a case of another three-dimensional data transmitting systems shown in FIGS. 8B to 8E, quality of 3D images to be displayed is worse than the case of the transmission by means of the frame sequential system. Therefore, as to a still image of the 3D system, a high-quality three-dimensional photo can be provided to the user by the above display operation. On the other hand, as to a moving image of the 3D system, one frame including two videos (for left eye and right eye) can be transmitted like the side-by-side system, so that transmission time is heightened. For this reason, an increase in size of a moving image processing circuit can be avoided. When image quality at the time of 3D display of a still image does not have to be taken into consideration, similarly to a moving image, the display mode of a still image in the reproducing apparatus 200 may be set according to whether the display apparatus 300 is compatible with three-dimensional display.

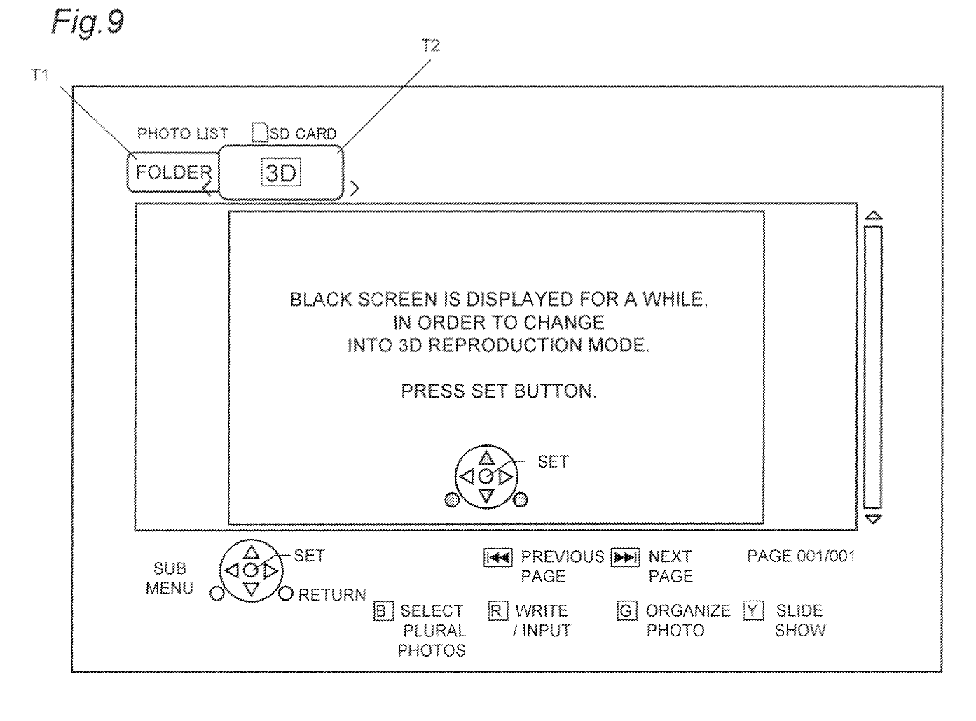

When the set button is pressed down by the user on the screen in FIG. 6, the reproducing apparatus 200 authenticates the display apparatus 300. When the three-dimensional mode is set after the authentication, a message screen shown in FIG. 9 is displayed. This is for allowing the user to know that when the two-dimensional display mode is switched into the three-dimensional display mode, the setting of the reproducing apparatus 200 and the setting of the display apparatus 300 are changed, and a defect of an image might occur. Thereafter, the reproducing apparatus 200 and the display apparatus 300 switch a video signal format from the two-dimensional system into the three-dimensional system.

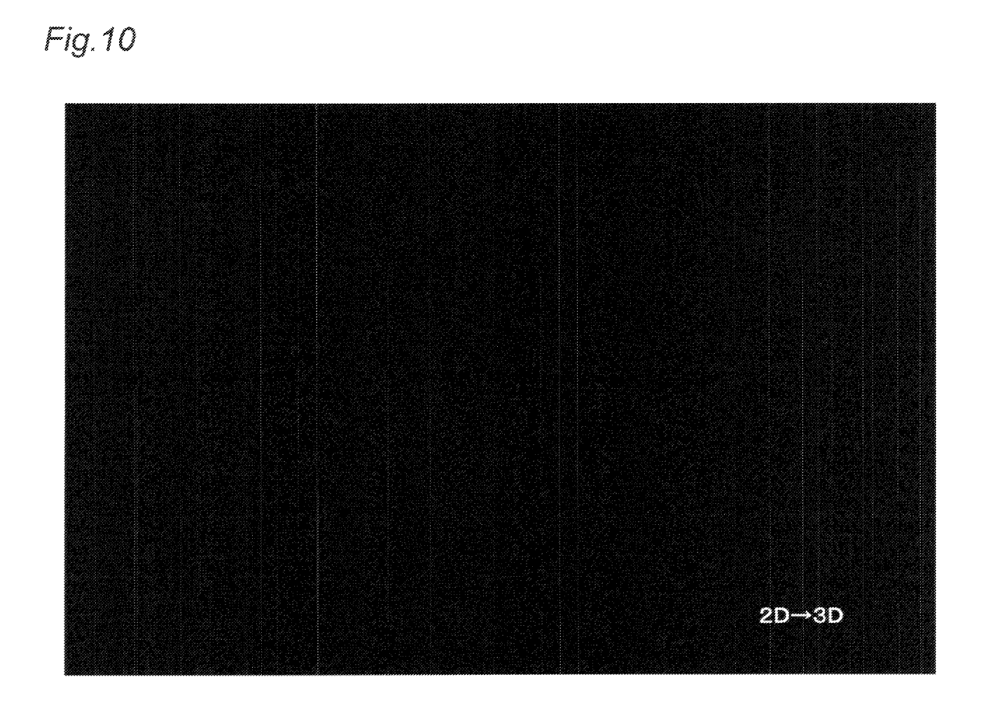

Thereafter, when the set button on the screen of FIG. 9 is pressed down by the user, the reproducing apparatus 200 displays a black screen shown in FIG. 10, thereafter the reproducing apparatus 200 switches the setting of the self apparatus. The black screen is displayed because when the display mode is changed from the two-dimensional mode into the three-dimensional mode, namely, in a transient state, a noise on the screen and a defect of the screen are masked.

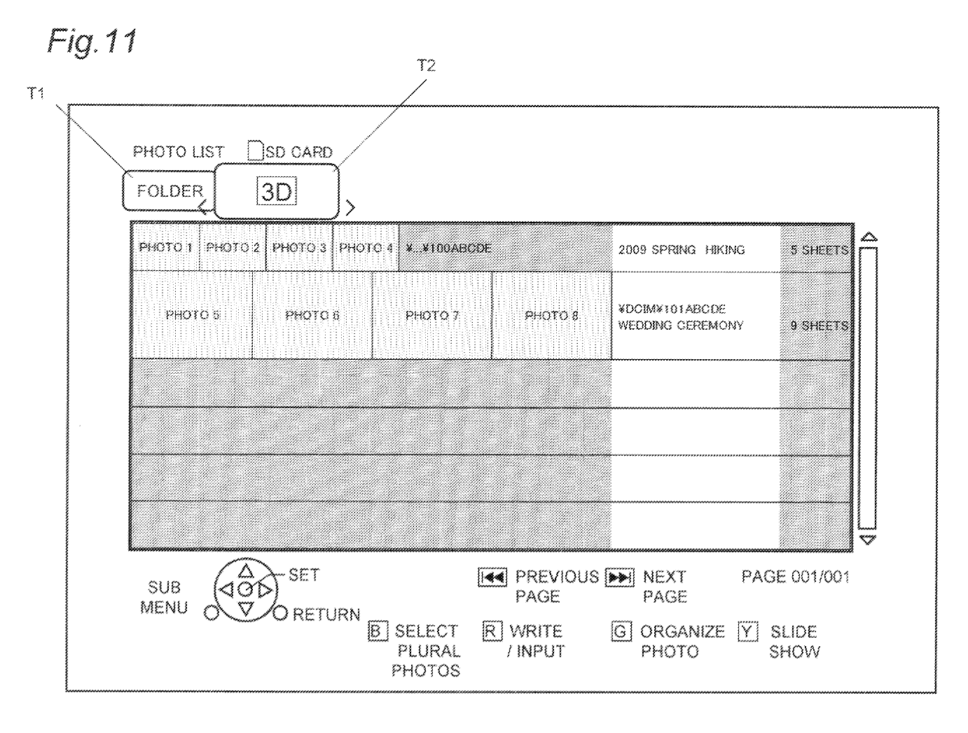

Thereafter, the reproducing apparatus 200 read an MPO file in each photo-folder from the captured data recorded in the recording medium 400 to display a photo list in the state that the “3D” tab T2 is selected as shown in FIG. 11is. Concretely, the reproducing apparatus 200 reads a file of which extension is “MPO”. That is to say, the reproducing apparatus 200 reads all still image data in each photo-folder that can be three-dimensionally displayed. The reproducing apparatus 200 displays some of thumbnail images included in the read file on the photo list. FIG. 11 illustrates each four thumbnail images (in FIG. 11, portions shown as photos 1 to 8) in each photo-folder.

In the first embodiment, as shown in FIG. 5 and FIG. 11, files to be displayed are different according to selected display formats. As a result, the user can securely reproduce data that is desired to be reproduced in a desired display format.

In the first embodiment, data to be read is selected by using an extension of the file at the time of switching the tab. In such a manner, time required for displaying the photo list can be further shortened. For this reason, time from the display of the photo list to the reproduction can be further shortened.

Since the classification codes are stored in the MPO file, data that can be three-dimensionally displayed are classified (determined) based on the classification codes so that the data that can be three-dimensionally displayed can be classified more securely. However, when the classification codes of the files are checked one by one, the classifying process takes a lot of time, and thus the processing time up to the display of the photo list becomes long. In the first embodiment, therefore, at the time point of displaying the photo list, the classification using the classification codes is not performed and only simple classification is performed. As a result, the display of the photo list at a higher speed is realized. When the long processing time up to the display of the photo list is not a problem, after only the data that can be three-dimensionally displayed are selected based on the classification codes, the photo list may be displayed.

When the “folder” tab T1 is selected by the user's operation in a state that the “3D” tab T2 is selected, the reproducing apparatus 200 performs the following operation. In the middle of the user's operation, the following operation is not performed.

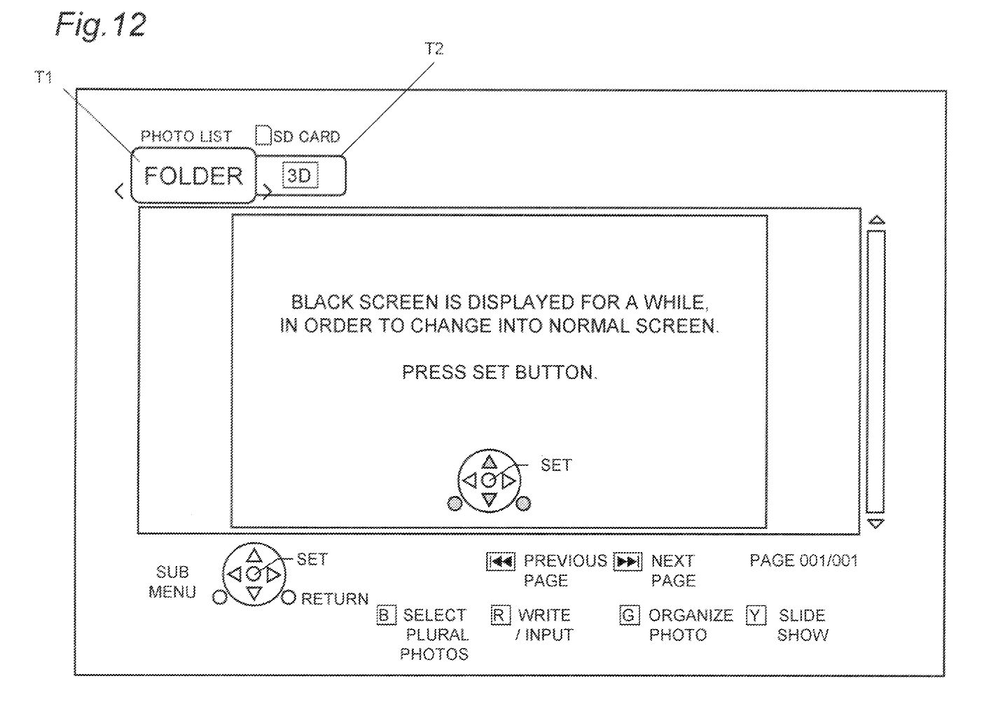

The reproducing apparatus 200 displays a display screen shown in FIG. 12 on the display apparatus 300. At this time, the reproducing apparatus 200 does not authenticate the display apparatus 300. It is because that when the display apparatus 300 can perform the three-dimensional display, normally the display apparatus 300 can also perform the two-dimensional display.

When the set button is operated by the user, the reproducing apparatus 200 sets the display mode to the two-dimensional mode, and displays a black screen similar to that in FIG. 10. Displaying the black screen is for masking a defect of the display screen at the time of changing the mode, similarly to the time when the two-dimensional mode is changed into the three-dimensional mode. The reproducing apparatus 200 displays the display screen shown in FIG. 5 on the display apparatus 300.

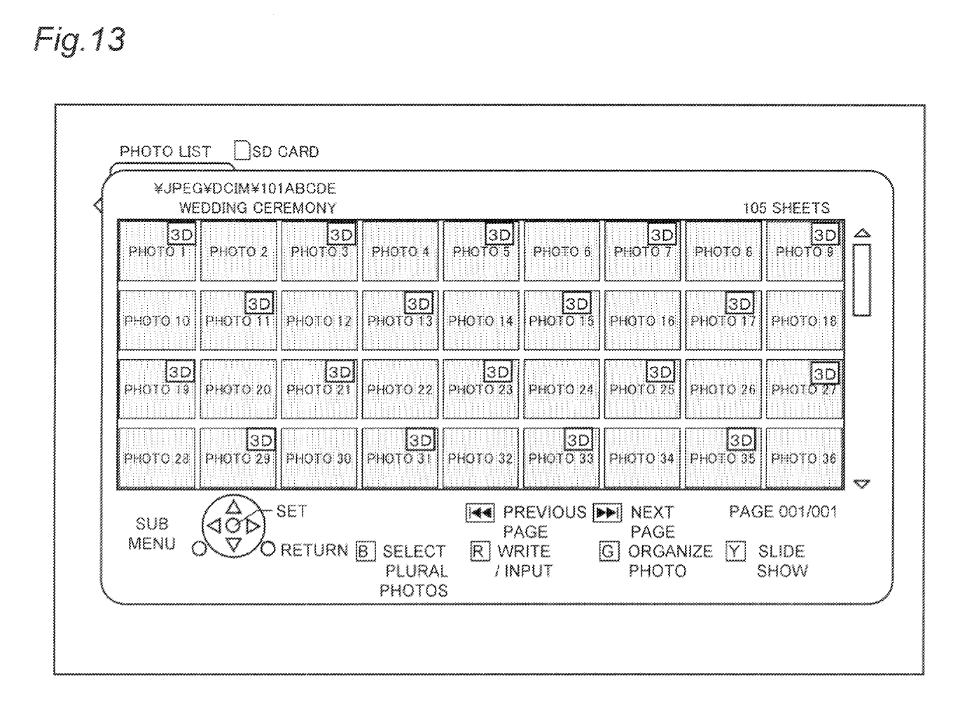

FIG. 13 is a diagram illustrating a state of a photo list in a case where one photo-folder is selected from photo-folders displayed on the photo list (FIG. 5) when the “folder” tab T1 is selected. The list in FIG. 13 includes a JPEG file and an MPO file. A predetermined icon (an icon “3D”: hereinafter, suitably referred to as the “3D icon”) is added to the MPO file.

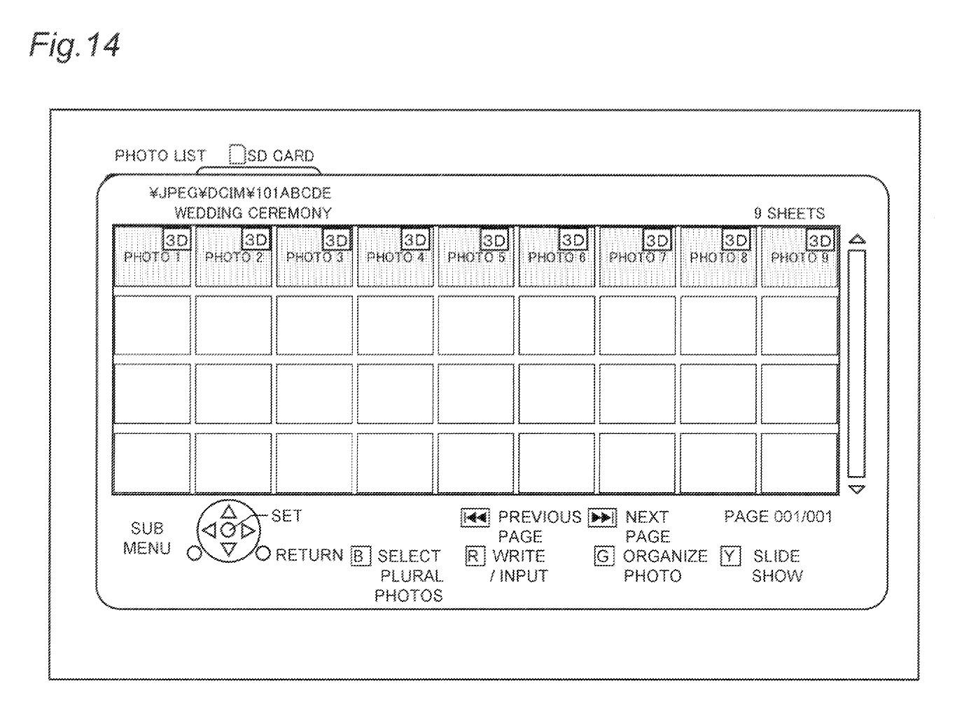

On the other hand, FIG. 14 is a diagram illustrating a state of a photo list when one photo-folder is selected from the photo-folders displayed on the photo list (FIG. 11) when the “3D” tab T2 is selected. The list in FIG. 14 includes only MPO files. A predetermined icon (3D icon) is added to the MPO files.

### 3-2. Reproducing Operation

### 3-2-1. 2D Reproducing Operation

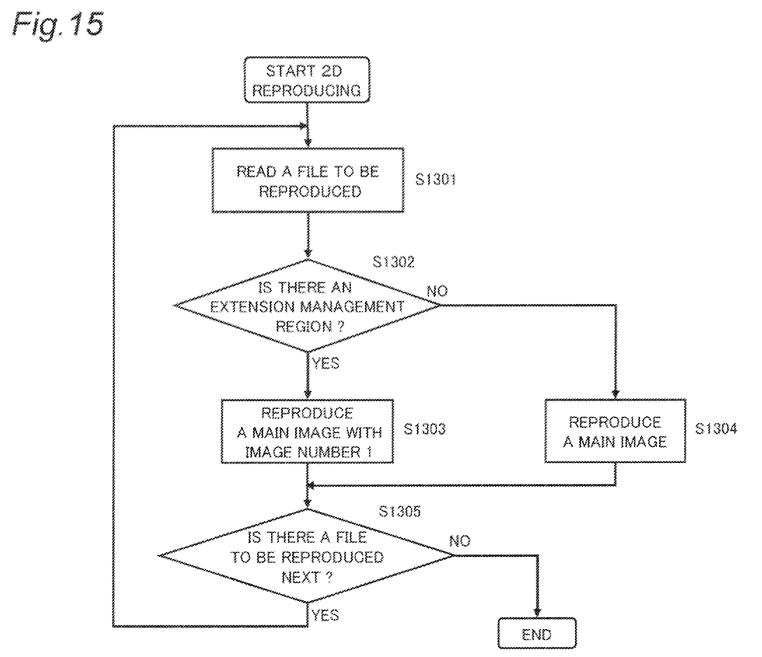

An operation for reproducing slide show performed by the reproducing apparatus 200 when the display mode is set to the two-dimensional mode will be described. When the reproducing apparatus 200 receives an instruction for reproducing the slide show from the user in the state that the display mode is set to the two-dimensional mode and the screen in FIG. 13 is displayed on the display apparatus 300, a process shown in a flowchart of FIG. 15 is started. A photo-folder “100ABCDE” of the recording medium 400 will be subject to the reproduction of the slide show.

First, the reproducing apparatus 200 reads one file to be reproduced from the recording medium 400 (step S1301). For example, the reproducing apparatus 200 reads “P0000001.jPG”.

Thereafter, the reproducing apparatus 200 determines whether an extension management region is present in the read file (step S1302). By this determination, it is determined whether the read file has the MPO file format. That is to say, when the extension region is not present, the determination can be made that the read file has the JPEG file format, and when the extension region is present, the determination can be made that the read file has the MPO file format.

When the extension management region is not present, namely, the file has the JPEG file format, the reproducing apparatus 200 reads image data in the main image region, and outputs the read image data to the display apparatus 300 (step S1304).

On the other hand, when the extension management region is present, namely, the file has the MPO file format, the reproducing apparatus 200 reads image data from the main image region of the individual image where an individual image number of the extension management region is “1”, and outputs the read image data to the display apparatus 300 (step S1303).

After step S1304 or step S1303, the reproducing apparatus 200 determines whether a file to be reproduced next is present (step S1305).

When a file to be reproduced next is present, the reproducing apparatus 200 returns to step S1301; and reads a file to be reproduced next (step S1301). For example, the reproducing apparatus 200 reads “P0000001.MPO” next.

On the other hand, when a file to be reproduced next is not present, the reproducing apparatus 200 ends the reproducing process.

Even when the image data included in the list displayed when the “folder” tab T1 is selected is image data that is captured to be capable of being three-dimensionally displayed, the two-dimensional display is performed. That is to say, all the image data included in the list displayed when the “folder” tab T1 is selected are two-dimensionally displayed. Therefore, even when the image data are sequentially reproduced, the two-dimensional display is not switched into the three-dimensional display and the three-dimensional display is not switched into the two-dimensional display. For this reason, a defect of the screen does not occur.

### 3-2-2. 3D Reproducing Operation

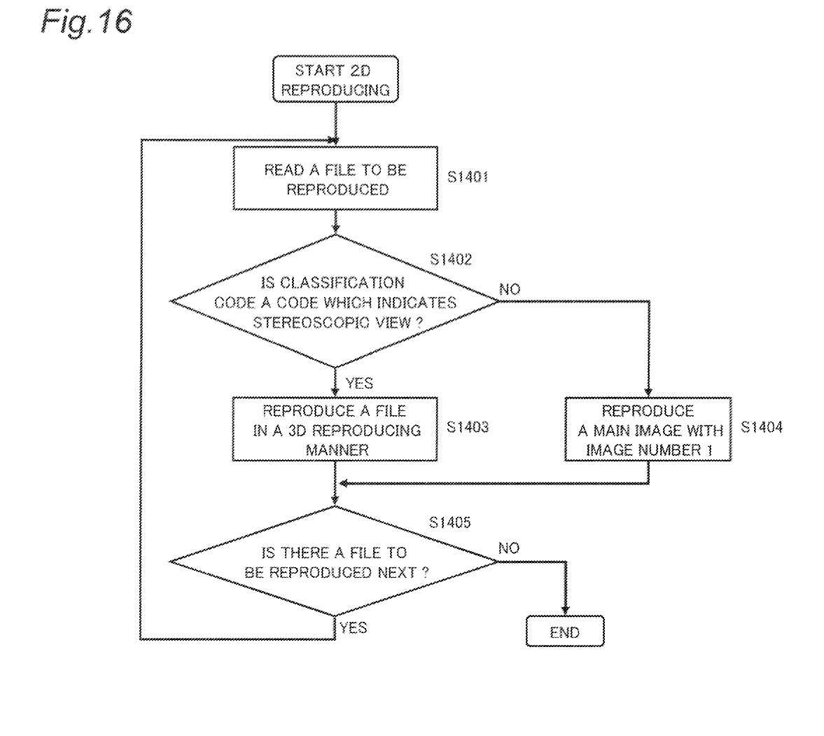

An operation for reproducing slide show performed by the reproducing apparatus 200 when the display mode is set to the three-dimensional mode will be described. When the reproducing apparatus 200 receives the instruction for reproducing slide show from the user in the state that the display mode is set to the three-dimensional mode and the screen in FIG. 14 is displayed on the display apparatus 300, a process shown in a flowchart of FIG. 16 is started. A photo-folder “100ABCDE” of the recording medium 400 will be subject to the reproduction of slide show.

First, the reproducing apparatus 200 reads one file to be reproduced from the recording medium 400 (step S1401). For example, the reproducing apparatus 200 reads “P0000001.MPO”.

Thereafter, the reproducing apparatus 200 determines whether the classification code in an extension management region of the read file is a code representing a stereoscopic view (step S1402).

When the classification code is not the stereoscopic view, the reproducing apparatus 200 reads image data from the main image region of the individual image where an individual image number of the extension management region is “1”, and outputs the read image data to the display apparatus 300 (step S1404). Concretely, the reproducing apparatus 200 outputs the read image data of the individual image with the individual image number “1” as image data for left eye and image data for right eye so that the image data is compatible with the frame sequential system. Therefore, as both the image data for right eye and the image data for left eye, the read image data are output.

On the other hand, when the classification code is the code representing the stereoscopic view, the reproducing apparatus 200 reads the image data in the main image region with the individual image number “1” as the image data for left eye, and the image data in the main image region with the individual image number “2” as the image data for right eye (step S1403). The reproducing apparatus 200 outputs video signals as the image data for left eye and the image data for right eye alternatively in this order according to the frame sequential system.

When step S1404 or step S1403 is ended, the reproducing apparatus 200 determines whether a file to be reproduced next is present (step S1405).

When a file to be reproduced next is present, the reproducing apparatus 200 returns to step S1401 and reads a file to be reproduced next (step S1401). For example, the reproducing apparatus 200 reads “P0000002.MPO”.

On the other hand, when a file to be reproduced next is not present, the reproducing apparatus 200 ends the reproducing process.

Images included in the list displayed when the “3D” tab T2 is selected are output in the format of the three-dimensional display. Even when a file to be reproduced is an MPO file and is not captured for the three-dimensional display (the classification code is not the code representing the stereoscopic view), this file is output so as to be compatible with the three-dimensional output format.

### 4. Conclusion

The reproducing apparatus 200 according to the first embodiment reads still image data from the recording medium 400 which stores a plurality of still image data, and can output information about the read still image data to the display apparatus 300. The reproducing apparatus 200 includes the remote controller light receiving unit 205 and the controller 204. The remote controller light receiving unit 205 receives an instruction by operation from the user. The controller 204 controls image information for controlling an image to be displayed on the display apparatus 300. The plurality of still image data include still image data (two-dimensional image data) with the JPEG format for enabling the two-dimensional display and still image data (three-dimensional image data) with the MPO format for enabling the three-dimensional display. The controller 204 has the two-dimensional mode and the three-dimensional mode as the display mode. The two-dimensional mode is for outputting still image data in a format for the two-dimensional display. The three-dimensional mode is for outputting still image data in a format for the three-dimensional display. The controller 204 outputs image information to the display apparatus 300. This image information is for selectively displaying a first list (an image list when the folder tab T1 is selected) as an image list including the still image data with the JPEG format and the still image data with the MPO format and a second list (an image list when the 3D tab T2 is selected) as an image list including only the still image data with MPO format. When the controller 204 receives an instruction for reproducing the still image data in the state that the image: list (the image list when the folder tab T1 is selected) including the still image data with the JPEG format and the still image data with the MPO format is displayed, the controller 204 outputs the still image data included in that image list in the two-dimensional mode to the display apparatus.

When the instruction for reproducing the still image data is received in the state that the image list (the image list when the folder tab T1 is selected) including the still image data with the JPEG format and the still image data with the MPO format is displayed, the still image data are output in the display format for the two-dimensional display. Therefore, even if the JPEG data and the MPO data are present in the mixed manner, the display mode on the side of the display apparatus 300 is not switched, authentication whether the three-dimensional display in the display apparatus 300 required in HDMI can be performed is not necessary, and a defect of an image does not occur.

Further, in the display apparatus 300 which can perform the three-dimensional display, the JPEG data and the MPO data included in the first list are two-dimensionally displayed, and MPO data (the classification code is “0202” (stereoscopic view)) included in the second list is three-dimensionally displayed. For this, reason, when any one of the lists is selected, the two-dimensional display and the three-dimensional display can be performed securely separately.

Further, when a selecting operation is performed so that the second list is displayed in the state that the first list is displayed, before the authentication on the display apparatus 300 is performed, the reproducing apparatus 200 displays the display screen showing a switching message on the display apparatus 300.

With such a configuration, the user's willingness to switch the list can be reflected.

When the selecting operation is performed so that the second list is displayed in the state that the first list is displayed, in the middle of the selecting operation, the reproducing apparatus 200 neither displays the display screen showing the message for switching the list on the display apparatus 300 nor authenticates the display apparatus 300.

When the process is performed in the state that the operation for the instruction by the user is not completed, the process that is performed when operation content is changed is wasted, but according to the first embodiment, such a waste can be avoided. Further, as a result of the non-performance of the wasted process, the speed of the display process can be heightened.

### Second Embodiment

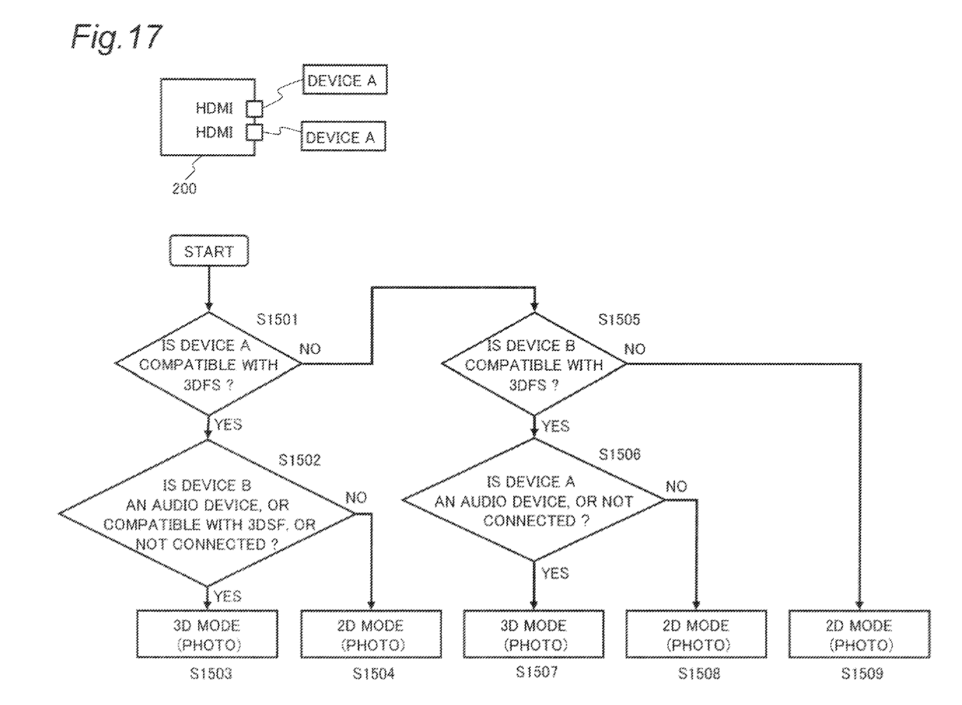

The first embodiment described a example of the reproducing apparatus 200 which has one input/output interface. Concretely, in the first embodiment, after performing the authentication operation, the reproducing apparatus 200 switches between the two-dimensional mode and the three-dimensional mode based on the pattern shown in FIG. 7. The second embodiment will describe the reproducing apparatus 200 provided with two input/output interfaces (for, example, HDMI interfaces) with reference to a flowchart shown in FIG. 17. A device that is connected to the first interface of the two input/output interfaces is a device A, and a device that is connected to the second interface is a device B. The devices A and B are a display apparatus, an AV amplifier, or the like.

In the second embodiment, the authenticating operation is performed according to the flowchart shown in FIG. 17, and the display mode is set.

First, the reproducing apparatus 200 determines whether the device A connected to the first interface is compatible with the frame sequential system (3DFS) (step S1501).

When the device A is compatible with the frame sequential system (3DFS), the reproducing apparatus 200 determines whether the device B connected to the second interface satisfies any one of the following conditions (step S1502):

1) the device B is not connected to the second interface (no detection of the connecting device for the second interface);

2) the device B is a sound device; or

3) the device B is compatible with the frame sequential system.

In 1), “no detection” includes not only the case where the device B is not connected but also a state that a power of the connected device B is OFF.

When any one of the above conditions 1) to 3) is satisfied, the reproducing apparatus 200 sets the display mode to the three-dimensional mode (step S1503). On the other hand, when any one of the above conditions 1) to 3) is not satisfied, the reproducing apparatus 200 sets the display mode to the two-dimensional mode (step S1504).

On the other hand, when the device A is compatible with the frame sequential system (3DFS) at step S1501, the reproducing apparatus 200 determines whether the device B connected to the second interface is compatible with the frame sequential system (step S1505).

When the device B is not compatible with the frame sequential system, the reproducing apparatus 200 sets the display mode to the two-dimensional mode (step S1509).

When the device B is compatible with the frame sequential system, the reproducing apparatus 200 determines whether the device A satisfies any one of the following conditions (step S1506).

1′) the device A is not connected to the first interface (no detection of the device connected to the first interface), or

2′) the device A is a sound device.

In 1′), “no detection” includes not only the case where the device A is not connected but also a state that the power of the connected device A is OFF.

When any one of the above conditions 1′) and 2′) is satisfied, the reproducing apparatus 200 sets the display mode to the three-dimensional mode (step S1507). On the other hand, when any one of the above conditions 1′) and 2′) is not satisfied, the reproducing apparatus 200 sets the display mode to the two-dimensional mode (step S1508).

In case that both the device A and the device B connected to the two input and output interfaces are display apparatuses and any one of the devices can reproduce a three-dimensional video but the other device cannot reproduce a three-dimensional video, setting of the display mode is switched as shown in FIG. 17. Thus, it is prevented that a video signal with a three-dimensional format is output from the reproducing apparatus 200, so that a defect in the other device that cannot reproduce a three-dimensional video can be prevented.

### Another Embodiment

In the above embodiment, the reproducing apparatus 200 reads various files recording image data therein from the recording medium 400 attachable and detachable to and from the self apparatus. However, the present invention is not limited to this, and the reproducing apparatus 200 may have a network connecting interface such as a connector for a LAN cable and a wireless LAN circuit and read various files from a recording medium provided to an external terminal using this network connecting interface. Further, the reproducing apparatus 200 may contain an HDD (hard disc drive), and read various files from the built-in HDD.

In the above embodiments, the display apparatus 300 provides a three-dimensional video for visually recognizing a three-dimensional video to the user via active shutter eyeglasses. However, the technical ideas in the first and second embodiments can be applied also to a three-dimensional video display system without using active shutter eyeglasses.

In the above embodiments, the reproducing apparatus 200 and the display apparatus 300 are connected by a wire. However, they may be wirelessly connected.

### INDUSTRIAL APPLICABILITY

The technical ideas of the above embodiments can be applied to the reproducing apparatus connected to the display apparatus that can three-dimensionally display still images and moving images and is.

What is claimed is:

1. A reproducing apparatus for reading still image data from a recording medium which stores a plurality of still image data and outputting information about the read still image data to a display apparatus, comprising:
an operation receiving unit operable to receive an instruction by operation; and
a display controller operable to control image information for controlling an image to be displayed on the display apparatus, wherein
the plurality of the still image data include still image data with a first format capable of being two-dimensionally displayed and still image data with a second format capable of being three-dimensionally displayed,
the display controller has a two-dimensional mode for outputting the still image data in a format for two-dimensional display and a three-dimensional mode for outputting the still image data in a format for three-dimensional display as an operating mode,
the display controller outputs image information for selectively displaying a first list including the still image data with the first format and the still image data with the second format, and a second list including only the still image data with the second format on the display apparatus,
when receiving an instruction for reproducing the still image data in a state that the first list is displayed, the display controller outputs the still image data included in the first list to the display apparatus in the two-dimensional mode.

2. The reproducing apparatus according to claim 1, wherein when receiving an instruction for displaying the second list, in the state that the first list is displayed, the display controller authenticates the display apparatus for confirming whether the display apparatus can perform three-dimensional display.

3. The reproducing apparatus according to claim 2 wherein, before the authentication is performed when the instruction for displaying the second list is received in the state that the first list is displayed, the display controller outputs information about a screen showing a message for switching the list to the display apparatus.

4. The reproducing apparatus according to claim 3, wherein even when the instruction for displaying the second list is received in the state that the first list is displayed, the display controller neither outputs the information about the screen showing the message to the display apparatus nor performs the authentication if the operation for the instruction is not completed.

5. The reproducing apparatus according to claim 1, wherein when receiving the instruction for reproducing the still image data in the state that the second list is displayed, the display controller outputs the still image data included in the second list to the display apparatus in the three-dimensional mode.

6. The reproducing apparatus according to claim 5, wherein when the display apparatus can perform the three-dimensional display but is not compatible with a frame sequential system, even if the display controller receives the instruction for reproducing the still image data in the state that the second list is displayed, the display controller outputs the still image data included in the second list to the display apparatus in the two-dimensional mode.
